(19) United States
(12) Patent Application Publication
(10) Pub. No.: US 2026/0097961 A1
(43) Pub. Date: Apr. 9, 2026

(54) ONE-POT METHOD FOR SELECTIVE N2O AND NO SYNTHESIS

(71) Applicant: UNIVERSITY OF NOTRE DAME DU LAC, South Bend, IN (US)

(72) Inventors: Jason Christopher HICKS, Granger, IN (US); Hope OTOR, South Bend, IN (US)

(21) Appl. No.: 19/352,937

(22) Filed: Oct. 8, 2025

Related U.S. Application Data
(60) Provisional application No. 63/705,317, filed on Oct. 9, 2024.

(51) Int. Cl. C01B 21/20; B01J 21/08; B01J 23/52

(52) U.S. Cl. CPC C01B 21/203; B01J 21/08; B01J 23/52

(57) ABSTRACT

Described herein is a one-pot method for selective N₂O and NO synthesis. A catalytic metal surface facilitates the oxidation of plasma-activated nitrogen species to produce nitrogen oxides (NO and N₂O). The metal surface oxygen adsorption strength is critical in directing product selectivity to different nitrogen oxide (NₓO_{y}) products. Temperature regimes are important in directing product selectivity using Pt catalyst.

### CROSS-REFERENCE TO RELATED APPLICATIONS

This application claims priority to U.S. Provisional Patent Application No. 63/705,317 filed on October 9, 2024, which is incorporated by reference herein in its entirety.

### FEDERALLY SPONSORED RESEARCH

This invention was made with government support under grant DE-SC0021107 awarded by the Department of Energy (DOE). The government has certain rights in the invention.

### BACKGROUND

N₂O is a very useful industrial chemical for selective oxidation chemistry and in N insertion in organic synthesis. Its applications include medical, automotive, rockets, food, and manufacturing. The current industrial process for N₂O synthesis involves a 6-step process involving NH₃ synthesis, NH₃ oxidation, NO oxidation, NO₃ formation from NO₂, then reaction with NH₃ and HNO₃ to make ammonium nitrate. In the last step, ammonium nitrate is thermally decomposed to create N₂O and water. Hence, process routes to directly produce N₂O from N₂ with fewer steps are desired.

What is needed is a one-pot method for selective N₂O and NO synthesis.

### SUMMARY

One embodiment described herein is a method for synthesizing nitrogen oxides (NₓO_{y}), the method comprising: introducing a first gaseous stream comprising nitrogen gas into a plasma reactor, energizing the plasma reactor, and generating a nitrogen plasma; contacting the nitrogen plasma with a noble metal catalyst and generating a plasma-activated nitrogen; introducing a second gaseous stream comprising oxygen gas into the plasma reactor, and oxidizing the plasma-activated nitrogen; and collecting a third gaseous stream comprising NₓO_{y}. In one aspect, the reactor comprises a dielectric barrier discharge plasma reactor or a radio frequency plasma reactor. In another aspect, the noble metal catalyst comprises a heterogeneous catalyst. In another aspect, the heterogeneous catalyst comprises a silica support. In another aspect, the heterogeneous catalyst comprises about 1%–30% by mass noble metal catalyst on a silica support. In another aspect, the heterogeneous catalyst comprises about 15% by mass noble metal catalyst on a silica support. In another aspect, the heterogeneous catalyst comprises nanoparticles. In another aspect, the noble metal catalyst comprises platinum, gold, or a combination thereof. In another aspect, introducing the first gaseous stream precedes introducing the second gaseous stream. In another aspect, the second gaseous stream comprises about 0.5–20 vol.% oxygen gas. In another aspect, the second gaseous stream comprises about 0.5–20 vol.% oxygen gas in nitrogen gas, a noble gas, or a combination thereof. In another aspect, the second gaseous stream comprises about 1 vol.% oxygen gas in nitrogen gas, a noble gas, or a combination thereof. In another aspect, the third gaseous stream comprises nitrogen oxide (NO), dinitrogen oxide (N₂O), or a combination thereof. In another aspect, generating the plasma-activated nitrogen occurs at a temperature from about 20–25 °C. In another aspect, oxidizing the plasma-activated nitrogen occurs at a temperature of up to about 500 °C. In another aspect, oxidizing the plasma-activated nitrogen occurs at a temperature from about 50–200 °C, and the third gaseous stream comprises dinitrogen oxide (N₂O). In another aspect, oxidizing the plasma-activated nitrogen occurs at a temperature from about 200–500 °C, and the third gaseous stream comprises nitrogen oxide (NO). In another aspect, the method further comprises introducing a fourth gaseous stream comprising hydrogen gas into the plasma reactor, thereby regenerating a heterogeneous catalyst.

Another embodiment described herein is nitrogen oxide or dinitrogen oxide produced by a method described herein.

Another embodiment described herein is a system for synthesizing nitrogen oxides (NₓO_{y}) comprising: a plasma reactor; a gold- or platinum-based catalyst; a nitrogen gas source; and an oxygen gas source.

Another embodiment described herein is a kit for producing nitrogen oxides (NₓO_{y}) comprising: a plasma reactor; a gold- or platinum-based catalyst; a nitrogen gas source; an oxygen gas source; and a receptacle for collecting nitrogen oxides.

### DESCRIPTION OF THE DRAWINGS

FIG. 1A shows a plot of mass normalized NO formation from plasma N₂ plasma activation for 15 minutes, followed by O₂ temperature ramp on 15 wt.% Pt/SiO₂. FIG. 1B shows a plot of mass normalized N₂O formation from plasma N₂ exposure for 15 minutes followed by O₂ temperature ramp on 15 wt.% Pt/SiO₂.

FIG. 2A shows a plot of mass normalized NO formation from plasma N₂ plasma activation for 30 minutes, followed by O₂ temperature ramp on 15 wt.% Pt/SiO₂. FIG. 2B shows a plot of mass normalized N₂O formation from plasma N₂ exposure for 30 minutes followed by O₂ temperature ramp on 15 wt.% Pt/SiO₂.

FIG. 3A shows a plot of mass normalized NO formation from plasma N₂ plasma activation for 60 minutes, followed by O₂ temperature ramp on 15 wt.% Pt/SiO₂. FIG. 3B shows a plot of mass normalized N₂O formation from plasma N₂ exposure for 60 minutes followed by O₂ temperature ramp on 15 wt.% Pt/SiO₂.

FIG. 4 shows a plot of mass normalized NO and N₂O formation from thermal N₂ activation at 200 °C for 1 h, followed by O₂ temperature ramp on 15 wt.% Pt/SiO₂.

FIG. 5 shows a plot of mass normalized NO and N₂O formation from plasma N₂ activation for 1 h, followed by O₂ temperature ramp on the SiO₂ support.

FIG. 6 shows a graph showing mass normalized N₂O formation from plasma N₂ plasma activation for 60 minutes, followed by O₂ temperature ramp in the range of 50–200 °C on 15 wt.% Pt/SiO₂. The formation of NO was not observed in this temperature range.

FIG. 7 shows a graph showing mass normalized NO formation from plasma N₂ plasma activation for 60 minutes, followed by O₂ temperature ramp in the range of 200–500 °C on 15 wt.% Pt/SiO₂. The formation of N₂O was not observed in this temperature range.

FIG. 8 shows a plot of mass normalized NO and N₂O formation from plasma N₂ plasma activation for 60 minutes, followed by O₂ temperature ramp on 15 wt.% Au/SiO₂. The selectivity favors N₂O.

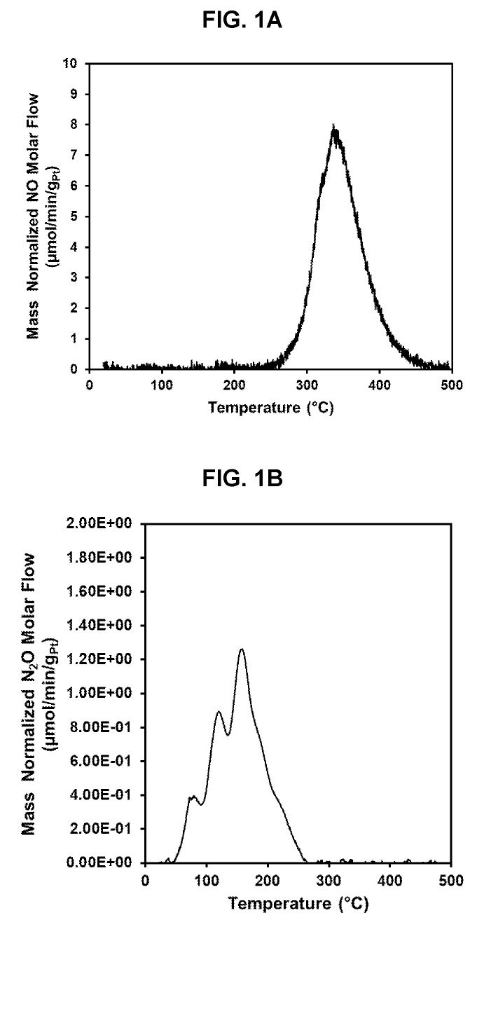

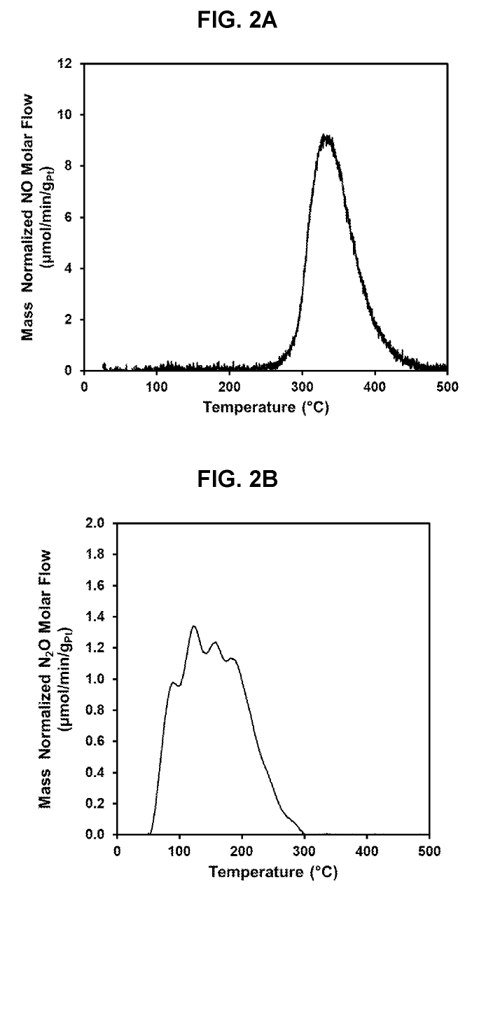

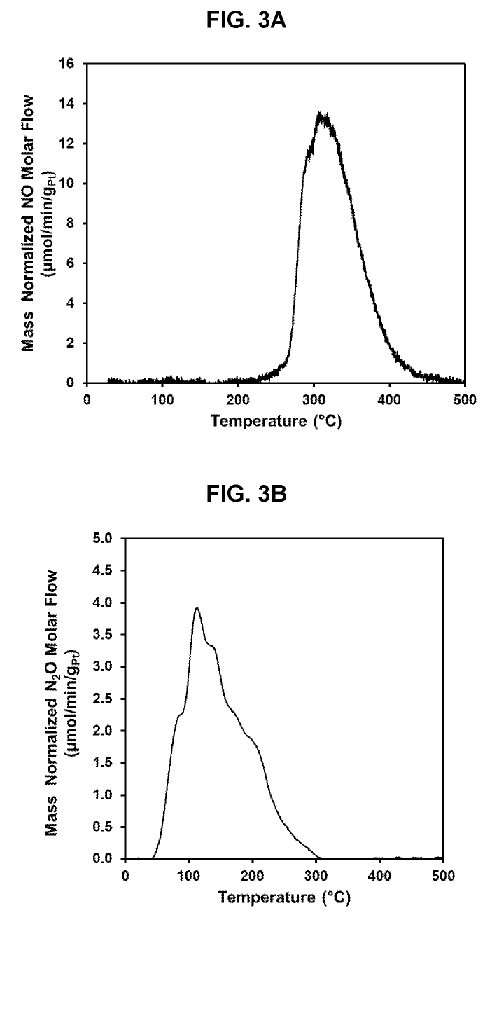

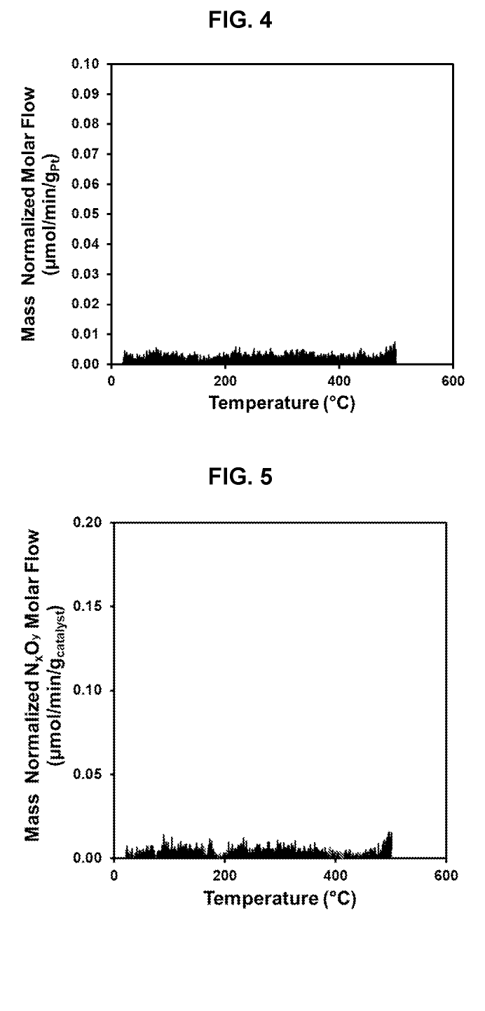

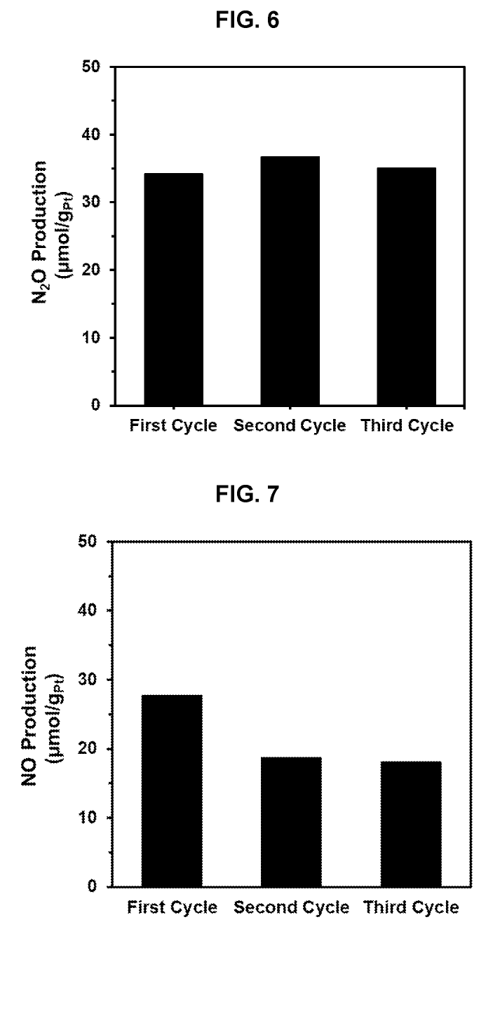

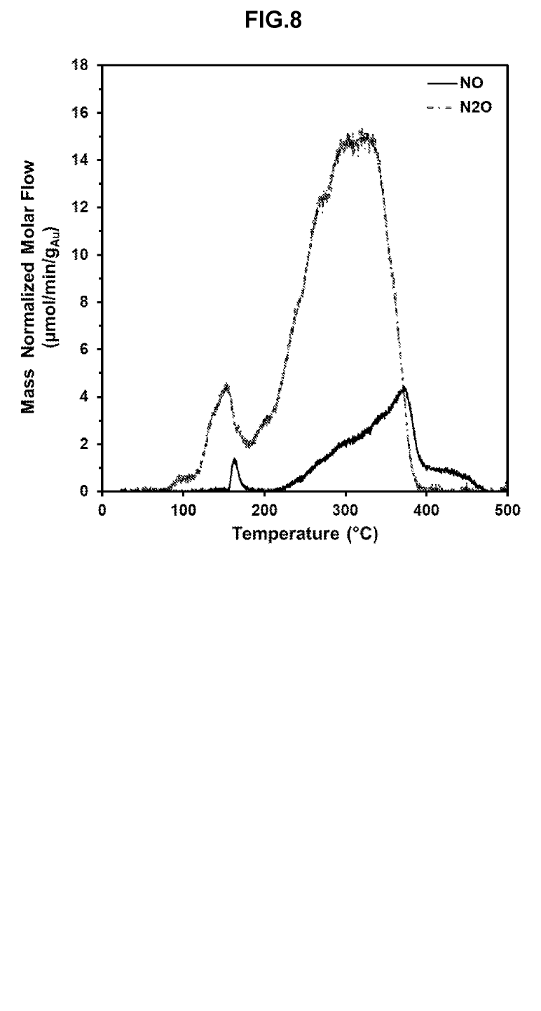

### DETAILED DESCRIPTION

Unless otherwise defined, all technical and scientific terms used herein have the same meaning as commonly understood by one of ordinary skill in the art. For example, any nomenclatures used in connection with, and techniques of chemistry described herein are well known and commonly used in the art. In case of conflict, the present disclosure, including definitions, will control. Exemplary methods and materials are described below, although methods and materials similar or equivalent to those described herein can be used in practice or testing of the embodiments and aspects described herein.

As used herein, terms such as “include,” “including,” “contain,” “containing,” “having,” and the like mean “comprising.” The present disclosure also contemplates other embodiments “comprising,” “consisting essentially of,” and “consisting of” the embodiments or elements presented herein, whether explicitly set forth or not. As used herein, “comprising,” is an “open-ended” term that does not exclude additional, unrecited elements or method steps. As used herein, “consisting essentially of” limits the scope of a claim to the specified materials or steps and those that do not materially affect the basic and novel characteristics of the claimed invention. As used herein, “consisting of” excludes any element, step, or ingredient not specified in the claim.

As used herein, the term “a,” “an,” “the” and similar terms used in the context of the disclosure (especially in the context of the claims) are to be construed to cover both the singular and plural unless otherwise indicated herein or clearly contradicted by the context. In addition, “a,” “an,” or “the” means “one or more” unless otherwise specified.

As used herein, the term “or” can be conjunctive or disjunctive.

As used herein, the term “and/or” refers to both the conjunctive and disjunctive.

As used herein, the term “substantially” means to a great or significant extent, but not completely.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to ± 10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “~” means “about” or “approximately.”

All ranges disclosed herein include both end points as discrete values as well as all integers and fractions specified within the range. For example, a range of 0.1–2.0 includes 0.1, 0.2, 0.3, 0.4 . . . 2.0. If the end points are modified by the term “about,” the range specified is expanded by a variation of up to ±10% of any value within the range or within 3 or more standard deviations, including the end points, or as described above in the definition of “about.”

As used herein, the terms “room temperature,” “RT,” or “ambient temperature” refer to the typical temperature in an indoor laboratory setting. In one aspect, the laboratory setting is climate controlled to maintain the temperature at a substantially uniform temperature or with a specific range of temperatures. In one aspect, “room temperature” refers a temperature of about 15–30 °C, including all integers and endpoints within the specified range. In another aspect, “room temperature” refers a temperature of about 15–30 °C; about 20–30 °C; about 22–30 °C; about 25–30 °C; about 27–30 °C; about 15–22 °C; about 15–25 °C; about 15–27 °C; about 20–22 °C; about 20–25 °C; about 20–27 °C; about 22–25 °C; about 22–27 °C; about 25–27 °C; about 15 °C ± 10%; about 20 °C ± 10%; about 22 °C ± 10%; about 25 °C ± 10%; about 27 °C ± 10%; ~20 °C, ~22 °C, ~25 °C, or ~27 °C, at standard atmospheric pressure.

As used herein, the terms “control,” or “reference” are used herein interchangeably. A “reference” or “control” level may be a predetermined value or range, which is employed as a baseline or benchmark against which to assess a measured result. “Control” also refers to control experiments or control cells.

An exemplary second gaseous stream may have a vol.% of oxygen (O₂) between 0.5 vol.% and 20 vol.%, including all endpoints, integers, and subranges within the specified range. In various instances, an exemplary second gaseous stream may have a vol.% of oxygen (O₂) between 0.5 and 20; 0.5 and 15; 0.5 and 10; 0.5 and 5; 0.5 and 2; 0.5 and 1.5; 1 and 20; 5 and 20; 10 and 20; or 15 and 20. In various instances, an exemplary second gaseous stream may have a vol.% of oxygen (O₂) no less than 0.5; no less than 1; no less than 1.5; no less than 2; no less than 5; no less than 10; no less than 15; or no less than 20. In various instances, an exemplary second gaseous stream may have a vol.% of oxygen (O₂) no greater than 20; no greater than 15; no greater than 10; no greater than 5; no greater than 2; no greater than 1.5; no greater than 1; or no greater than 0.5.

An exemplary heterogeneous catalyst may have a percent by mass of noble metal catalyst on a silica support between 1 and 30, including all endpoints, integers, and subranges within the specified range. In various instances, exemplary heterogeneous catalyst may have a percent by mass of noble metal catalyst on a silica support between 1 and 30; 1 and 25; 1 and 20; 1 and 15; 1 and 10; 1 and 5; 5 and 30; 10 and 30; 20 and 30; 25 and 30; 10 and 20; or 5 and 25. In various instances, an exemplary heterogeneous catalyst may have a percent by mass of noble metal catalyst on a silica support of no less than 1; no less than 5; no less than 10; no less than 15; no less than 20; no less than 25; or no less than 30. In various instances, an exemplary heterogeneous catalyst may have a percent by mass of noble metal catalyst on a silica support of no greater than 30; no greater than 25; no greater than 20; no greater than 15; no greater than 10; no greater than 5; or no greater than 1.

One embodiment described herein is a method for synthesizing nitrogen oxides (NₓO_{y}), the method comprising: introducing a first gaseous stream comprising nitrogen gas into a plasma reactor, energizing the plasma reactor, and generating a nitrogen plasma; contacting the nitrogen plasma with a noble metal catalyst and generating a plasma-activated nitrogen; introducing a second gaseous stream comprising oxygen gas into the plasma reactor, and oxidizing the plasma-activated nitrogen; and collecting a third gaseous stream comprising NₓO_{y}. In one aspect, the reactor comprises a dielectric barrier discharge plasma reactor or a radio frequency plasma reactor. In another aspect, the noble metal catalyst comprises a heterogeneous catalyst. In another aspect, the heterogeneous catalyst comprises a silica support. In another aspect, the heterogeneous catalyst comprises about 1%–30% by mass noble metal catalyst on a silica support. In another aspect, the heterogeneous catalyst comprises about 15% by mass noble metal catalyst on a silica support. In another aspect, the heterogeneous catalyst comprises nanoparticles. In another aspect, the noble metal catalyst comprises platinum, gold, or a combination thereof. In another aspect, introducing the first gaseous stream precedes introducing the second gaseous stream. In another aspect, the second gaseous stream comprises about 0.5–20 vol.% oxygen gas. In another aspect, the second gaseous stream comprises about 0.5–20 vol.% oxygen gas in nitrogen gas, a noble gas, or a combination thereof. In another aspect, the second gaseous stream comprises about 1 vol.% oxygen gas in nitrogen gas, a noble gas, or a combination thereof. In another aspect, the third gaseous stream comprises nitrogen oxide (NO), dinitrogen oxide (N₂O), or a combination thereof. In another aspect, generating the plasma-activated nitrogen occurs at a temperature from about 20–25 °C. In another aspect, oxidizing the plasma-activated nitrogen occurs at a temperature of up to about 500 °C. In another aspect, oxidizing the plasma-activated nitrogen occurs at a temperature from about 50–200 °C, and the third gaseous stream comprises dinitrogen oxide (N₂O). In another aspect, oxidizing the plasma-activated nitrogen occurs at a temperature from about 200–500 °C, and the third gaseous stream comprises nitrogen oxide (NO). In another aspect, the method further comprises introducing a fourth gaseous stream comprising hydrogen gas into the plasma reactor, thereby regenerating a heterogeneous catalyst.

Another embodiment described herein is nitrogen oxide or dinitrogen oxide produced by a method described herein.

Another embodiment described herein is a system for synthesizing nitrogen oxides (NₓO_{y}) comprising: a plasma reactor; a gold- or platinum-based catalyst; a nitrogen gas source; and an oxygen gas source.

Another embodiment described herein is a kit for producing nitrogen oxides (NₓO_{y}) comprising: a plasma reactor; a gold- or platinum-based catalyst; a nitrogen gas source; an oxygen gas source; and a receptacle for collecting nitrogen oxides.

It will be apparent to one of ordinary skill in the relevant art that suitable modifications and adaptations to the compositions, formulations, methods, processes, and applications described herein can be made without departing from the scope of any embodiments or aspects thereof. The compositions and methods provided are exemplary and are not intended to limit the scope of any of the specified embodiments. All of the various embodiments, aspects, and options disclosed herein can be combined in any variations or iterations. The scope of the compositions, formulations, methods, and processes described herein include all actual or potential combinations of embodiments, aspects, options, examples, and preferences herein described. The exemplary compositions and formulations described herein may omit any component, substitute any component disclosed herein, or include any component disclosed elsewhere herein. The ratios of the mass of any component of any of the compositions or formulations disclosed herein to the mass of any other component in the formulation or to the total mass of the other components in the formulation are hereby disclosed as if they were expressly disclosed. Should the meaning of any terms in any of the patents or publications incorporated by reference conflict with the meaning of the terms used in this disclosure, the meanings of the terms or phrases in this disclosure are controlling. Furthermore, the foregoing discussion discloses and describes merely exemplary embodiments. All patents and publications cited herein are incorporated by reference herein for the specific teachings thereof.

### EXAMPLES

### Materials

The reactant gases used in this study include 99.999% N₂ (Airgas UHP300), 99.999% H₂ (Airgas HY UHP300), and 1 vol.% O₂ in a He gas mixture (Airgas). The mass spectrometer (MS) calibrations to quantify the NO and N₂O production were carried out using 1000 ppm NO and N₂O in He cylinders, respectively. The Pt and Au catalysts for this study were synthesized on a silica gel support (Davisil 636 35–60 mesh). The catalysts were synthesized using metal precursors H₂PtCl₆ (Beantown Chemical) and AuCl₃ (Sigma-Aldrich).

### Catalysts Synthesis

The catalysts were synthesized using incipient wetness impregnation technique. The silica gel support was calcined at 500 °C for 6 h to remove any impurities prior to metal impregnation. Appropriate amounts of metallic precursors corresponding to a 15 wt.% nominal metal loading were dissolved in water and then added dropwise to a calcined silica gel support until incipient wetness was achieved. The as-synthesized catalysts were dried overnight at 120 °C and calcined at 450 °C for 3 h. Both catalysts were reduced at 200 °C for 5 h.

### Catalysts Characterization

X-ray diffraction measurements were conducted using a Bruker D8 Advance Davinci powder diffractometer (Cu Kα X-ray source). Scans were collected over a 2θ range of 30–70° with a step size of 0.02° and a scan speed of 1 s per step. The crystallite size was calculated using the Scherrer equation with a shape factor of 0.9. Textural properties of the catalysts were determined using Quantochrome 2200e physisorption unit, and the BET surface area was estimated from N₂ adsorption performed at 77 K. Samples were degassed overnight at 200 °C under vacuum before N₂ physisorption measurements. Metal site densities were assessed from CO pulse chemisorption analysis. The CO pulse chemisorption measurement was performed using a Micromeritics Chemisorb 2750. All catalysts were pretreated in hydrogen and purged with He before chemisorption with the CO probe gas. Pulse injections were performed until saturation, where no further CO uptake was observed after three consecutive injections. NO temperature-programmed desorption was also performed over the catalysts. NO was exposed over the catalyst surface at 200 °C for 1h and then purged with He at the same temperature for 30 minutes before cooling to room temperature to remove loosely physisorbed NO species on the catalyst surface. The temperature was then ramped to 500 °C in He, and NO evolution was monitored using the mass spectrometer.

### Reactor Setup and Experiment Design

The dielectric barrier discharge (DBD) packed bed reactor used here has been reported in previous studies in the group. See Mehta et al., Nature Catalysis 1(4): 269–275 (2018). The system consists of a cylindrical quartz tube with an inner diameter of 5 mm and a wall thickness of 1mm, with a silica frit placed in the center to support the catalyst while allowing reactant gases to flow through. A 1.5 mm diameter tungsten rod was inserted at the center of the reactor to act as the inner electrode, while a 6 cm length stainless-steel mesh (200–1400 steel mesh McMaster-Carr) wrapped around the quartz tube served as the outer electrode. The electrodes were connected to an AC high-voltage power supply (PMV500) with a frequency range of 20–25 kHz to generate the DBD plasma in the reactor with a discharge gap and discharge volume of 1.75 mm and approximately 1 cm³, respectively. An oscilloscope connected to a high-voltage attenuator and a monitor capacitor was used to monitor the power supplied to the system. The plasma power supplied was evaluated by integrating the area bound by the Q-V Lissajous curves and multiplying by the frequency reported in the literature. The reactor effluent gases were connected to an in-line mass spectrometer (MS; Pfeiffer Omnistar GSD320) to monitor the gas composition from the reactor as a function of time.

For the sequential plasma-TPO reactions, 200 mg of catalyst was packed in the discharge zone of the reactor. Before the plasma treatment, the catalysts were pretreated in H₂ at 500 °C for 1 h to reduce surface oxide formed from exposure to air and purged with helium at 500 °C to remove surface-bound hydrogen. After cooling to room temperature, a 10 W N₂ plasma activation was performed for 1 h unless otherwise stated, after which a temperature ramp was conducted in a 1 vol.% O₂/He gas stream. The MS was set to monitor m/z of 4, 28, 30, 44, and 46, corresponding to the signal for He, N₂, NO, N₂O, and NO₂, respectively.

With respect to temperature effects and the experiment design, temperatures above 500 °C would result in sintering and provide no additional benefit since the gas products would have already desorbed.

### Example 1

200 mg of 15 wt.% Pt/SiO₂ was first pretreated with H₂ at 500 °C for 1 h and then purged with He gas at 500 °C for 30 minutes. Next, the gas flow to the reactor was switched to N₂. A 10 W N₂ plasma was exposed to the 15 wt.% Pt/SiO₂ for 15 minutes. The N₂ plasma was then turned off, and flow switched to a 1 vol.% O₂/He followed by a 15 °C/min ramp up to 500 °C. The NO formation was 40.38 µmol/gPt and the N₂O formation was 10.04 µmol/gPt, where the N₂O desorbed at lower temperatures and NO at higher temperatures.

### Example 2

Next, another experiment was performed using 200 mg of 15 wt.% Pt/SiO₂, which was first pretreated with H₂ at 500 °C for 1 h and then purged with He gas at 500 °C for 30 minutes. A N₂ gas stream was then fed to the reactor. Next, a 10 W N₂ plasma was exposed to the 15 wt.% Pt/SiO₂ for 30 minutes. The N₂ plasma was then turned off, and flow switched to a 1 vol.% O₂/He followed by a 15 °C/min ramp up to 500 °C. The NO formation was 40.50 µmol/gPt, and the N₂O formation was 13.51 µmol/gPt, where the N₂O desorbed at lower temperatures and NO at higher temperatures.

### Example 3

Next, another experiment was performed using 200 mg of 15 wt.% Pt/SiO₂, which was first pretreated with H₂ at 500 °C for 1 h and then purged with He gas at 500°C for 30 minutes. This time, a 10 W N₂ plasma was exposed to the 15 wt.% Pt/SiO₂ for 60 minutes. The N₂ plasma was then turned off, and flow switched to a 1 vol.% O₂/He followed by a 15 °C/min ramp up to 500 °C. The NO formation was 77.65 µmol/gPt, and the N₂O formation was 29.23 µmol/gPt, where the N₂O desorbed at lower temperatures and NO at higher temperatures.

### Example 4

A control experiment was performed in which N₂ was exposed thermally without plasma stimulation. To do this, the Pt catalyst was pretreated as described earlier at 500 °C for 1 h with H₂ and then purged with He gas at 500 °C for 30 minutes. Next, N₂ was fed thermally at 200 °C for 1 h. After that, a 1 vol.% O₂/He was fed, and the temperature was ramped to 500 °C using the same 15 °C/min ramp rate. Under these experimental conditions, no product formation for NO and N₂O was observed.

### Example 5

A control experiment was conducted with the SiO₂ support without any metal loading. In this case, the SiO₂ was pretreated in He gas at 500 °C for 1 h. Next, a 10 W N₂ plasma was fed to the SiO₂ for 1 h. Next, the gas flow was switched to a 1 vol.% O₂/He feed stream, and the temperature was ramped to 500 °C with a 15 °C/min ramp rate. Under these conditions, no product formation was observed.

### Example 6

Next, cyclic studies were performed to evaluate the stability of the 15 wt.% Pt/SiO₂ catalyst at the lower temperature regimes. The catalyst was pretreated as described above with H₂ (500 °C, 1 h) and He (500 °C, 30 minutes). 10 W N₂ plasma was fed to the reactor for 1 h, after which a thermal ramp of 15 °C/min was performed in 1 vol.% O₂/He up to 200 °C and held constant at 200 °C for 5 minutes. No NO formation was observed in this regime, and only N₂O formation was observed. Further, the N₂O formation was observed to be stable at 34.24 µmol/gPt, 36.70 µmol/gPt, and 35.09 µmol/gPt for the first, second, and third cycles, respectively. It was also observed that N₂O selectivity was approximately 80% in the 50–200 °C temp range on a 15 wt.% Au/SiO₂ catalyst.

### Example 7

Similarly, cyclic studies were performed at a higher temperature regime over the 15 wt.% Pt/SiO₂ catalyst. For this protocol, the catalyst was also pretreated as described earlier (500 °C, 1 h) and He (500 °C, 30 minutes). Here, 10 W N₂ plasma was conducted at 200 °C for 1 h, and then the thermal ramp was conducted with a 1 vol.% O₂/He ramp from 200 °C to 500 °C with a 15 °C/min ramp rate. Only NO observation was observed here, and no N₂O formation was observed. The NO formation was 27.67 µmol/gPt after the first cycle, 18.77 µmol/gPt, and 18.08 µmol/gPt after the second and third cycles.

### Example 8

A different metal catalyst, 15 wt.% Au/SiO₂, was used. The 15 wt.% Au/SiO₂ catalyst was pretreated similarly to the 15 wt.% Au/SiO₂ catalyst: a 500 °C treatment in H₂ for 1 h and a 500 °C treatment in He gas for 1 h. Next, 10 W N₂ plasma was fed for 1 h. Then, the gas was switched to 1 vol.% O₂/He and ramped thermally to 500 °C with a 15 °C/min ramp rate. Both N₂O and NO formation were observed at similar temperature regimes over the catalyst. The N₂O formation was 140 µmol/gAu, and the NO formation was 25.27 µmol/gAu.

What is claimed:

1. A method for synthesizing nitrogen oxides (NₓO_{y}), the method comprising:
introducing a first gaseous stream comprising nitrogen gas into a plasma reactor, energizing the plasma reactor, and generating a nitrogen plasma;
contacting the nitrogen plasma with a noble metal catalyst and generating a plasma-activated nitrogen;
introducing a second gaseous stream comprising oxygen gas into the plasma reactor, and oxidizing the plasma-activated nitrogen; and
collecting a third gaseous stream comprising NₓO_{y}.

2. The method of claim 1, wherein the reactor comprises a dielectric barrier discharge plasma reactor or a radio frequency plasma reactor.

3. The method of claim 1, wherein the noble metal catalyst comprises a heterogeneous catalyst.

4. The method of claim 3, wherein the heterogeneous catalyst comprises a silica support.

5. The method of claim 3, wherein the heterogeneous catalyst comprises about 1%–30% by mass noble metal catalyst on a silica support.

6. The method of claim 3, wherein the heterogeneous catalyst comprises about 15% by mass noble metal catalyst on a silica support.

7. The method of claim 3, wherein the heterogeneous catalyst comprises nanoparticles.

8. The method of claim 1, wherein the noble metal catalyst comprises platinum, gold, or a combination thereof.

9. The method of claim 1, wherein introducing the first gaseous stream precedes introducing the second gaseous stream.

10. The method of claim 1, wherein the second gaseous stream comprises about 0.5–20 vol.% oxygen gas.

11. The method of claim 9, wherein the second gaseous stream comprises about 0.5–20 vol.% oxygen gas in nitrogen gas, a noble gas, or a combination thereof.

12. The method of claim 9, wherein the second gaseous stream comprises about 1 vol.% oxygen gas in nitrogen gas, a noble gas, or a combination thereof.

13. The method of claim 1, wherein the third gaseous stream comprises nitrogen oxide (NO), dinitrogen oxide (N₂O), or a combination thereof.

14. The method of claim 1, wherein generating the plasma-activated nitrogen occurs at a temperature from about 20–25 °C.

15. The method of claim 1, wherein oxidizing the plasma-activated nitrogen occurs at a temperature of up to about 500 °C.

16. The method of claim 1, wherein oxidizing the plasma-activated nitrogen occurs at a temperature from about 50–200 °C, and the third gaseous stream comprises dinitrogen oxide (N₂O).

17. The method of claim 1, wherein oxidizing the plasma-activated nitrogen occurs at a temperature from about 200–500 °C, and the third gaseous stream comprises nitrogen oxide (NO).

18. The method of claim 1, further comprising introducing a fourth gaseous stream comprising hydrogen gas into the plasma reactor, thereby regenerating a heterogeneous catalyst.

19. Nitrogen oxide or dinitrogen oxide produced by the method of claim 1.

20. A system for synthesizing nitrogen oxides (NₓO_{y}) comprising:
a plasma reactor;
a gold- or platinum-based catalyst;
a nitrogen gas source; and
an oxygen gas source.

21. A kit for producing nitrogen oxides (NₓO_{y}) comprising:
a plasma reactor;
a gold- or platinum-based catalyst;
a nitrogen gas source;
an oxygen gas source; and
a receptacle for collecting nitrogen oxides.
